(19) United States
(12) Patent Application Publication
(10) Pub. No.: US 2001/0035663 A1
(43) Pub. Date: Nov. 1, 2001

(54) Auxiliary sun visor attachment for increasing the sun blocking area of a conventional sun visor

(76) Inventors: Anthony Garcia, North Hills, CA (US); Michael Townsend, Stapleford (GB)

Correspondence Address: ROBERT J. SCHAAP, Suite 188, 21241 Ventura Boulevard, Woodland Hills, CA, 91364, US

(21) Appl. No.: 09/802,563

(22) Filed: Mar. 8, 2001

Related U.S. Application Data
(60) Provisional application No. 60/187,908, filed on Mar. 8, 2000.

(51) Int. Cl. B60J 3/02

(52) U.S. Cl. 296/97.6

(57) ABSTRACT

An attachment for an existing sun visor in an automotive vehicle in the nature of a sleeve which is adapted to slidably extend over the sun visor. In this case, the attachment can be shifted longitudinally relative to the sun visor in order to block direct exposure to the sun which is not covered by the existing sun visor of the vehicle. The sleeve type attachment also prevents marring or soiling of the sun visor. The attachment can be made in a permanent form or it can be constructed so as to be a disposal throw-away item. The attachment is designed so that it will block direct exposure to the sun without substantially interfering with the visibility of the driver or a passenger of the vehicle.

### BACKGROUND OF THE INVENTION

1. Field of the Invention

This invention relates in general to certain new and useful improvements in auxiliary attachments for sun visors in automotive vehicles and, more particularly, to an attachment, in the nature of a sleeve, adapted to extend over a portion of the sun visor in order to block direct viewing of the sun without substantially interfering with visibility of the occupants of the vehicle.

2. Brief Description of Related Art

In essentially all automotive vehicles, including passenger automobiles, trucks, pick-up trucks and the like, a constant concern of all drivers and, for that matter, front seat passenger occupants, is the direct viewing exposure to the sun. This is a perplexing problem, particularly for the driver of the vehicle, in that direct exposure to sunlight will interfere with his or her ability to observe road conditions.

One of the problems frequently encountered with the use of the conventional sun visor is that the sun visor, although pivotally movable downwardly and upwardly, does not shift horizontally with movement of the vehicle to conform to road orientation. Frequently, any street or highway will rotate through an arc, however large or small, to conform to natural terrain or to move around existing building structures. Thus, and when the driver is driving his or her vehicle in one direction, a slight rotation of the road will cause re-orientation of the vehicle so that the driver may be looking into a direct path of the sunlight. This scenario keeps changing in accordance with variations in the road orientation.

One of the problems of the conventional sun visor is that, since it is essentially fixed in a position transverse to the movement of the car, it cannot accommodate any change in road orientation or direction. Moreover, the sun visor in many vehicles is limited in size because of other structures which may interfere with the movement of the sun visor upwardly and downwardly, such as, for example, a rear view mirror in the vehicle. It would be desirable to be able to shift the sun visor transversely in order to accommodate any changes in road orientation or direction. However, with essentially all vehicles this capability does not exist.

It would be desirable to provide an attachment to a sun visor of a vehicle which allowed for blocking of a view of the sun during movement of a vehicle from one orientation and direction to another. It would also be desirable to provide for an attachment of this type which was relatively inexpensive and could be universally used in a variety of vehicles.

### OBJECTS OF THE INVENTION

It is, therefore, one of the primary objects of the present invention to provide an auxiliary sun visor attachment, in the nature of a sleeve, which is capable of being disposed over a sun visor and shiftable transversely with respect to the direction of the vehicle.

It is another object of the present invention to provide an auxiliary sun visor attachment of the type stated which is capable of being transversely shiftable on a sun visor with respect to an orientation of the vehicle without interfering with other structural components in the vehicle.

It is a further object of the present invention to provide an auxiliary sun visor attachment of the type stated which is capable of being universally employed in a variety of different vehicles.

It is an additional object of the present invention to provide an auxiliary sun visor attachment of the type stated which can be constructed at a relatively low cost.

It is another salient object of the present invention to provide an auxiliary sun visor attachment of the type stated which can be constructed as a disposable throw-away item or as a permanently usable item on a sun visor of an automotive vehicle.

It is yet an additional object of the present invention to provide a method of adjustably blocking a view of a vehicle driver or passenger with respect to the sun when the vehicle changes an orientation or direction.

It is also an object of the present invention to provide an attachment for a sun visor of an automotive vehicle which is capable of effectively extending the length of that sun visor.

With the above and other objects in view, our invention resides in the novel features of form, construction, arrangement and combination of parts and components presently described and pointed out in the claims.

### BRIEF SUMMARY OF THE INVENTION

An auxiliary sun visor attachment for an automotive vehicle, which exists in the nature of a sleeve, adapted to slidably extend over an existing sun visor of a vehicle. Sun visors are supplied as a standard item in practically all automotive vehicles for the obvious purpose of blocking a driver or passenger's view into direct sunlight and which could temporarily blind the driver or passenger.

Generally, the sun visor is mounted on a rod secured to a roof or other portion of an automotive vehicle. The opposite end is provided with a latch for being releasably attached to a hook also secured to the roof or other portion of an automotive vehicle. In this way, the sun visor can pivot upwardly to a position where it is nested against the inner surface of the roof or to a lower position where it can be used to partially block the direct view of the sun. It can also be rotated to one side with unhooked.

Although many, if not most, of the sun visors are capable of pivoting about an axis toward a side window of the vehicle, as aforesaid, the sun visor is effectively fixed in its length. Thus, depending on the exact orientation of the vehicle, a direct view of the sun frequently arises because of the space between the inner edge of the sun visor and a rear view mirror. The same holds true in that there is frequently a space between the left side of the sun visor when facing the dashboard and a window or door. Although the conventional sun visor is effective in most situations to block a direct view of the sun, it does present limitations, in that it frequently is not capable of blocking direct views of the sun due to changing orientation and direction because of road conditions.

The present invention therefore provides a sun visor attachment, in the nature of a sleeve, which is capable of slidable disposition over a sun visor. In this case, the sun visor is unhooked from its latched position in the vehicle and the sleeve is slid over the sun visor from its inner end thereof, that is, the end which is not secured to a ceiling or other portion of a vehicle.

The sleeve-like device is relatively inexpensively produced in the nature of a single sheet which is folded to provide a front panel and a rear panel hingedly connected along a fold line. A locking tab is arranged to be bent over the inner panel and adhesively or otherwise secured thereto, thereby leaving open transverse ends capable of being slid lengthwise over a sun visor.

The locking tab, which is capable of being secured to the inner panel, can be secured in a variety of positions so as to accommodate the overall width of the sun visor. For this purpose, the tab is connected to the outer panel through a fold line and additional parallel fold lines are provided to enable adjustability in the position of attachment of the tab to the inner panel and, hence, adjustability in the size.

Both panels are provided with a cut-out or recessed portion on a side edge to allow for accommodation of a rear view mirror.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a perspective view of one embodiment of an auxiliary sun visor attachment constructed in accordance with and embodying the present invention and shown in relationship to a conventional sun visor of an automotive vehicle;

FIG. 2 is a plan view of a sheet of material which is used for producing the auxiliary sun visor attachment of the present invention;

FIG. 3 is a schematic plan view showing an auxiliary sun visor attachment of the present invention on a sun visor of an automotive vehicle in relationship to a rear view mirror thereof when in the nested position, that is, in a position where it is not in use;

FIG. 4 is an end elevational view of the auxiliary sun visor attachment of the present invention;

FIG. 5 is a plan view similar to FIG. 4, and showing the auxiliary sun visor attachment in a horizontally shifted position with respect to the sun visor of an automotive vehicle also in a nested position and with respect to a rear view mirror thereof;

FIG. 6 is a plan view, similar to FIG. 5, and showing the auxiliary sun visor attachment and the sun visor of the vehicle in a position where it has been lowered to a position of use;

FIG. 7 is a plan view, similar to FIG. 6, and showing the position of the auxiliary sun visor attachment and the sun visor when the sun visor attachment has been horizontally shifted with respect to the sun visor;

FIG. 8 is a fragmentary perspective view of a modified form of auxiliary sun visor attachment in accordance with the present invention;

FIG. 9 is an end elevational view of the auxiliary sun visor attachment of FIG. 8;

FIG. 10 is a perspective view of still another modified form of auxiliary sun visor attachment in accordance with the present invention; and

FIG. 11 is a plan view of a sheet of material used to make the auxiliary sun visor attachment of FIG. 10.

### DETAILED DESCRIPTION OF A PREFERRED EMBODIMENT

Referring now in more detail and by reference characters to the drawings, which illustrate practical embodiments of the present invention, A₁ designates an auxiliary sun visor attachment for use with an existing sun visor of an automotive vehicle.

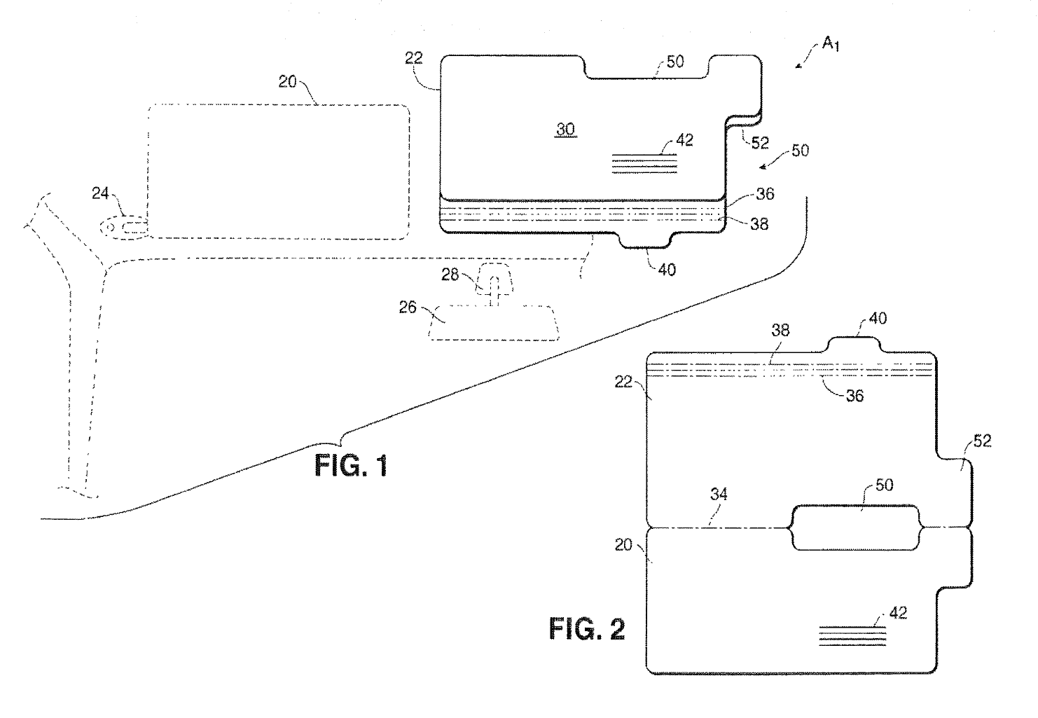

Referring to FIG. 1, it can be observed that the conventional automotive vehicle is typically provided with an existing or original equipment sun visor 20 generally connected to the roof of an automotive vehicle by means of a hinge arm (not shown) and located on an end of the existing sun visor. At its opposite end, the sun visor is provided with a latch 22 cooperating with a releasable lock for releasably latching the sun visor in a position where it will not swing with the arm in an arcuate path. The sun visor can also be raised and lowered from an upper nested position against the roof liner of a vehicle to a lower sun blocking position, as shown in FIG. 1.

The conventional automotive vehicle, such as a passenger automotive vehicle, is also equipped with an interior rear view mirror 26 mounted on a mirror arm 28 and the latter of which is, again, usually secured to the roof of an automotive vehicle or a portion of the windshield frame or the windshield thereof. The conventional automotive vehicle would include one sun visor for a driver's side position or left side position, as shown in FIG. 1, and normally includes another existing sun visor on the opposite side of the rear view mirror for a passenger of the automotive vehicle. Thus, the sun visor, as shown, is that located on the left side of the vehicle when facing the rear view mirror.

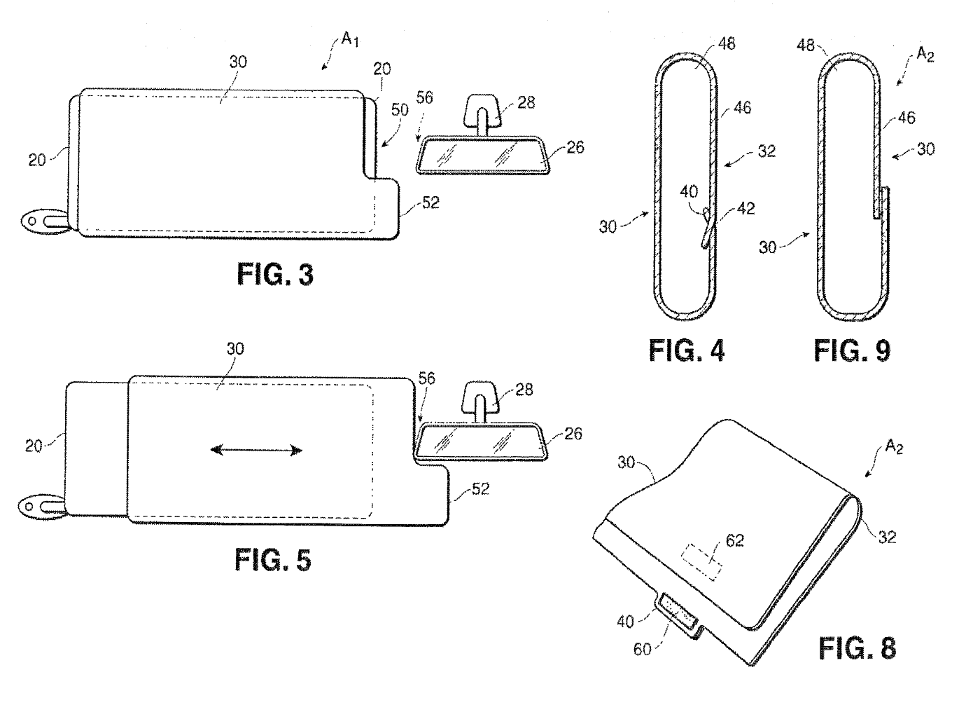

The auxiliary sun visor attachment of the present invention is shown in relationship to a conventional standard equipment sun visor of an automotive vehicle 20. FIG. 3 shows the position of the sun visor and the sun visor attachment of the invention when the latter is in the nested position, that is, when it is not in use, as aforesaid. The auxiliary sun visor attachment Al generally includes an outer or front panel 30 and an inner or rear panel 32 connected through a fold line acting as a hinge and constituting a lower edge 34, whenin the nested position. Both of the panels 30 and 32 are relatively flat, as shown, and the rear panel 32 is provided with an outwardly struck tab 36 defined by a plurality of generally parallel spaced apart alternate fold lines 38. A locking flange 40 is integral with the upper end of the tab 36 and is adapted for insertion into any of a plurality of generally parallel spaced apart flange receiving slots 42 formed in the front panel 30.

In accordance with the above-identified construction, it can be seen that the inner panel 32 can be folded over at any of the parallel fold lines 38 and which automatically becomes an upper margin of the auxiliary sun visor attachment (reference being made to FIG. 1) in order to accommodate the size of the sun visor. Thus, the tab 36 can be folded at any of the fold lines 38 in order to form one horizontal margin of the auxiliary sun visor attachment. In this respect, the locking flange 40 would be inserted into the appropriate slot 42 to thereby define the overall vertical size of the auxiliary sun visor attachment.

FIG. 2 illustrates the auxiliary sun visor attachment in an original sheet form. It can be observed that the entire auxiliary sun visor attachment can be formed of a single sheet of material which is capable of being folded or bent to form the desired configuration and retain that configuration. By reference to FIG. 4, it can be observed that the sun visor attachment A₁, when in the assembled position, forms a generally rectangular outer frame 46 with an inner opening 48 to receive the existing original equipment sun visor of an automotive vehicle. The auxiliary sun visor attachment of the present invention may be provided with a recessed area or opening 50 along its upper margin in order to accommodate a locking mechanism of the existing original equipment sun visor of the automotive vehicle, such as the latch member 22 and the lock 24. In this way, the auxiliary sun visor attachment of the present invention does not interfere with the latching operation of the existing original equipment sun visor.

In addition, the sheet of material which forms the auxiliary sun visor attachment A₁ is also formed with a pair of protruding tabs 52 along its right-hand margin edge, adjacent the lower margin 34 (reference being made to FIG. 1).

By reference to FIGS. 3 and 5, the position of the auxiliary sun visor attachment A₁ is more fully illustrated when in the nested or not used position. The auxiliary sun visor attachment fits generally over the existing original equipment sun visor of the automotive vehicle. Generally, due to the fact that most passenger automobiles have approximately the same overall width, the general overall length of the sun visor from vertical edge to vertical edge is similar. Thus, since the auxiliary sun visor attachment is in the nature of a sleeve, it fits over the existing sun visor, as shown. FIG. 3 shows the sun visor of the vehicle and the sun visor attachment in a position where it is normally nested against the roof of the vehicle. In this respect, the tabs 32 are in a generally lowermost position and would be in a true lowermost position if the sun visor were nested in a truly vertical arrangement. FIG. 5, however, shows the fact that the sun visor can even be shifted when in the nested or rest position.

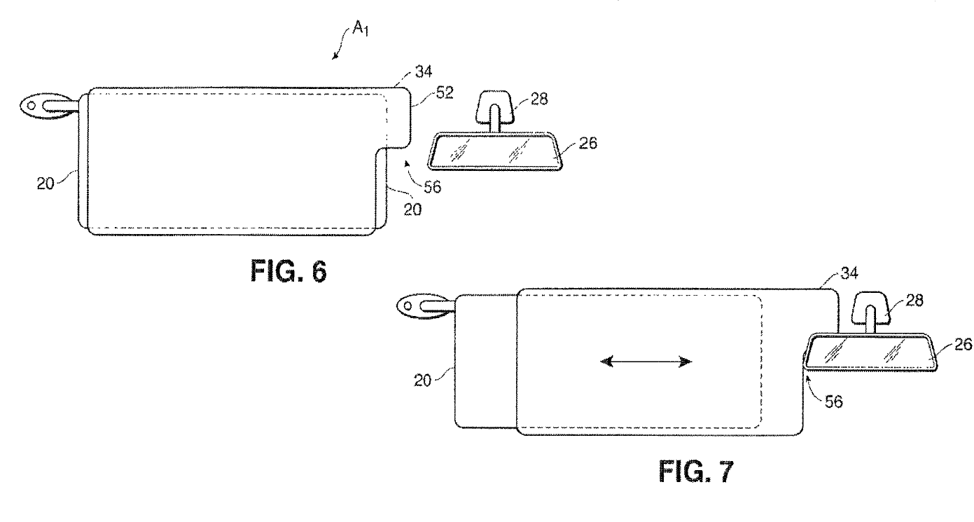

FIGS. 6 and 7 illustrate the position of the sun visor of the vehicle and the sun visor attachment of the invention when the sun visor has been shifted to its lower or use position. In this case, and specifically, FIG. 6 shows the sun visor in a position where it is normally located with respect to the sun visor. FIG. 7 shows the position of the sun visor attachment when it is shifted horizontally with respect to the sun visor.

It can be observed that there is frequently an area of space 56 existing between the rear view mirror and the original equipment sun visor 20 of the automotive vehicle. This space, even though it may be of a relatively small width, compared to the overall width of the automotive vehicle, is still sufficient, such that a driver or occupant of the vehicle may be in a position where there is a direct view of the sun, depending upon the orientation of the vehicle. Even if the vehicle orientation should change from time to time, the viewer is still nevertheless confronted with the uncomfortable position of looking directly into the sun. Even a momentary exposure to a direct view of the sun can temporarily interfere with the sight of a driver, thereby causing an accident with an automotive vehicle.

The auxiliary sun visor attachment of the present invention is capable of being slid longitudinally relative to the sun visor 20 so that it effectively blocks that area 56, as best shown in FIG. 7. In this way, the auxiliary sun visor attachment of the present invention is effectively designed to enable convenient positioning thereof so that any areas of the sun which are not directly blocked by the existing original equipment sun visor are blocked by the auxiliary sun visor attachment of the invention. In this respect, it can be observed that the tabs 52 will generally fit behind the rear view mirror and the body of the auxiliary sun visor attachment, along with the tabs, thereby provides a complete sun blocking of a direct view of the sun without blocking complete view of the driver or the occupant of the vehicle.

It can also be observed that even when the sun visor and the sun visor attachment thereon are in the nested position when normally not in use, as shown in FIG. 3, that the sun visor attachment can be shifted. In this way, it is also possible to block sun rays with the tab 32 when the sun visor is in the nested position.

With respect to the following described embodiment A₂, as well as yet an additional embodiment A₃, like reference numerals which were used in the description of the embodiment Al will also be used for like components in these subsequent embodiments.

FIGS. 8 and 9 illustrate a modified form of auxiliary sun visor attachment A₂ which is very similar to the auxiliary sun visor attachment A₁. The auxiliary sun visor attachment A₂ differs only from the auxiliary sun visor attachment A₁, in that the locking flange 40 is provided with an adhesive locking section 60 capable of being attached to a mating adhesive section 62 on the front panel 30. In this respect, the provision of the adhesive means is also effective and further illustrates the fact that other types of releasable locking mechanisms can be used for securing the flange 40 to the front panel 30.

The auxiliary sun visor attachment of the present invention is preferably formed of a foldable and bendable material, as aforesaid, and may include, for example, relatively thin bendable plastics which will retain a bent shape or paper board materials, such as conventional cardboard and the like. In this way, the auxiliary sun visor attachment of the invention may become a disposable item and even function as a give-away promotional item. The surface of one or both of the panels may be provided with advertising or promotional material identifying a particular product or service. However, the auxiliary sun visor attachment of the invention can be constructed of a more durable and permanent material, if desired. In this way, it can be formed in the desired shape and offered as a unit in that form. Thus, and in this respect, the auxiliary sun visor attachment can be constructed so as to constitute either a permanently formed device or a give-away disposable item.

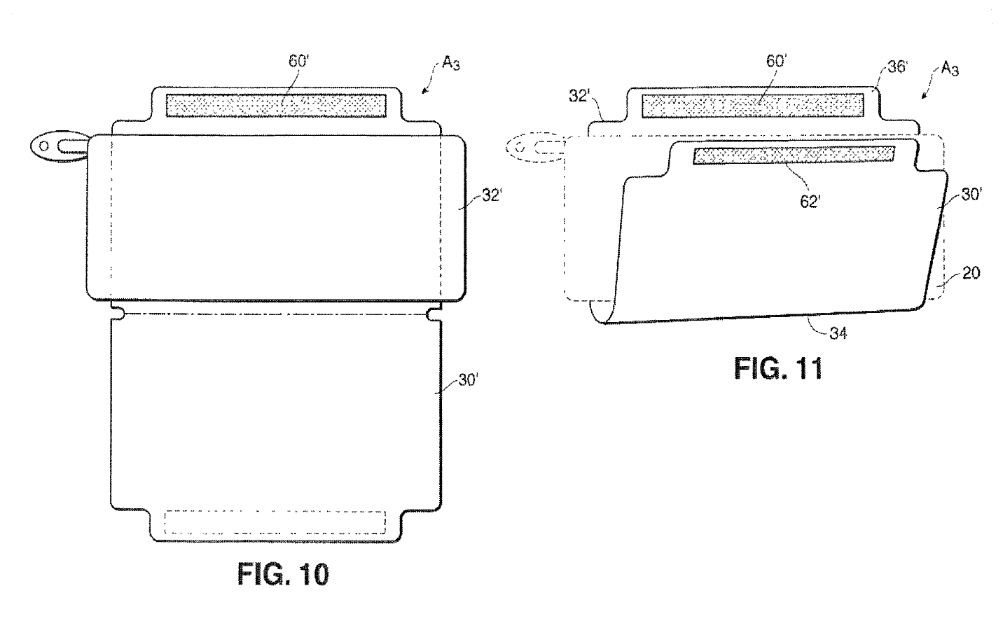

FIGS. 10 and 11 illustrate yet another auxiliary sun visor attachment A₃ for use with an existing original equipment sun visor of an automotive vehicle. The auxiliary sun visor attachment A₃ is very similar in construction to the auxiliary sun visor attachment A₂, except that in this case, it is provided with generally rectangular front and rear panels 30′ and 32′. Moreover, the panels, e.g. 30′ and 32′ are not necessarily provided with a cut-out area 50 and they are not provided with the edge extending tabs 52. Rather, the panels are generally rectangular in shape, as aforesaid. Moreover, an upper locking tab 36′ has a greater longitudinal dimension than does the corresponding locking tab 36 and, similarly, the auxiliary sun visor attachment A₃ is also provided with adhesive areas 60′ and 62′ which has a greater length than the corresponding adhesive area 60′ and 62′, respectively.

The auxiliary sun visor attachment A₃ also demonstrates the fact that it is not necessary to form the panels with the shape as illustrated in FIG. 1 and, similarly, it is not necessary to use purely rectangular panels, as shown. However, these two forms are the preferred forms.

Thus, there has been illustrated and described a unique and novel auxiliary sun visor attachment for increasing sun blocking area of a conventional sun visor and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. An auxiliary sun visor attachment for use with a sun visor of an automotive vehicle and capable of extending the effective length of the sun visor to block potential direct views of the sun as a result of changes in vehicle orientation and direction, said auxiliary sun visor attachment comprising:
a) a first relatively flat panel capable of lying on one side of a sun visor;
b) a second relatively flat panel capable of lying on an opposite side of said sun visor;
c) means hingedly connecting the first panel to the second panel so that they may be disposed in generally parallel relationship to one another on opposite sides of a sun visor; and
d) a tab on a longitudinal edge of one of said panels and capable of being folded over for securement to the other of said panels in a desired position to thereby form a sleeve capable of being longitudinally shifted with respect to a sun visor on which it is mounted.

2. The auxiliary sun visor attachment of claim 1 further characterized in that said panel from which said tab extends is provided with a plurality of spaced apart fold lines allowing for the tab to be secured to the other of the panels in any of a variety positions thereby adjusting the size of the sleeve to accommodate a sun visor.

3. The auxiliary sun visor attachment of claim 1 further characterized in that said attachment is formed of a material which is capable of being foldable and bendable but which nevertheless provides some structural rigidity.

4. The auxiliary sun visor attachment of claim 3 further characterized in that said sun visor attachment is constructed from a paper or paperboard material.

5. The auxiliary sun visor attachment of claim 1 further characterized in that both of said panels have a matching cut-out to accommodate a rear view mirror.

6. The auxiliary sun visor attachment of claim 1 further characterized in that said attachment is constructed as a disposable throw-away item.

7. The auxiliary sun visor attachment of claim 1 further characterized in that said attachment is constructed of a relatively permanent material so that said attachment is a relatively permanently usable device.

8. An auxiliary sun visor attachment for use with a sun visor of an automotive vehicle and capable of extending the effective length of the sun visor to block potential direct views of the sun as a result of changes in vehicle orientation and direction, said auxiliary sun visor attachment comprising:
a) an elongate sleeve having a pair of oppositely disposed generally spaced apart and relatively parallel panels which are connected at their upper end and at their lower end;
b) said panels forming an elongate opening extending through said device allowing for receipt of a sun visor; and
c) said sun visor attachment being formed of a material which allows said attachment to be slidable longitudinally over the sun visor of a vehicle to effectively adjust the overall length of the sun visor.

9. The auxiliary sun visor attachment of claim 8 further characterized in that said panel from which said tab extends is provided with a plurality of spaced apart fold lines allowing for the tab to be secured to the other of the panels in any of a variety positions thereby adjusting the size of the sleeve to accommodate a sun visor.

10. The auxiliary sun visor attachment of claim 8 further characterized in that said attachment is formed of a material which is capable of being foldable and bendable but which nevertheless provides some structural rigidity.

11. The auxiliary sun visor attachment of claim 10 further characterized in that said sun visor attachment is constructed from a paper or paperboard material.

12. The auxiliary sun visor attachment of claim 8 further characterized in that both of said panels have a matching cut-out to accommodate a rear view mirror.

13. The auxiliary sun visor attachment of claim 8 further characterized in that said attachment is constructed as a disposable throw-away item.

14. The auxiliary sun visor attachment of claim 8 further characterized in that said attachment is constructed of a relatively permanent material so that said attachment is a relatively permanently usable device.

15. A method of blocking a direct view of sunlight as a result of changes in the orientation or direction of an automotive vehicle, said method comprising:
a) disconnecting a latched end of a sun visor in an automotive vehicle so that it is hingedly mounted at one end and free at the opposite end;
b) inserting a sleeve like device over the free end of said sun visor and shifting the sleeve like device to a desired position on the sun visor;
c) relatching the free end of the sun visor so that it is again fixed; and
d) slidably positioning the attachment with respect to the sun visor so as to block a direct view of the sun if the visor itself does not provide that blocking of the direct view of the sun.

16. The method of claim 15 further characterized in that said method comprises folding a first panel over and with respect to a second panel so that it is generally parallel to and spaced apart from the first panel thereby forming an opening to receive a sun visor.

17. The method of claim 16 further characterized in that said method comprises securing a tab on one of said panels to the opposite of said panels in order to form a sleeve like device capable of being extended over said sun visor.

17. The method of claim 16 further characterized in that said method comprises adjustably positioning the tab with respect to the panel to which it is attached in order to adjustably size the opening of the sun visor attachment.
